(19) United States
(12) Patent Application Publication
(10) Pub. No.: US 2012/0244243 A1
(43) Pub. Date: Sep. 27, 2012

(54) IMPRINT LITHOGRAPHY TEMPLATE, METHOD OF FABRICATING AN IMPRINT LITHOGRAPHY TEMPLATE, AND METHOD OF FORMING A PATTERN

(76) Inventor: Yoshihito KOBAYASHI, Tokyo (JP)

(21) Appl. No.: 13/428,187

(22) Filed: Mar. 23, 2012

(30) Foreign Application Priority Data
Mar. 24, 2011 (JP) P2011-065281

(51) Int. Cl. B28B 11/08; B29C 59/16; B29C 59/00

(52) U.S. Cl. 425/385; 427/504; 216/11

(57) ABSTRACT

According to one embodiment, an imprint-lithography template comprises: a second substrate; a first photo-curable resin provided on a main surface of the first substrate and having a first concave-convex pattern; and a second photo-curable resin provided on the main surface of the first substrate, having a second concave-convex pattern different in pattern density from the first concave-convex pattern, and having optical transmittance different from that of the first photo-curable resin.

### FIELD

Embodiments described herein relate generally to an imprint lithography template, a method of fabricating an imprint lithography template, and a method of forming a pattern.

### BACKGROUND

In recent years, as a replacement for photolithography, imprint lithography, in particular, nanoimprint lithography, in which a minute pattern formed on a template is transferred into a resin layer has actively been developed. As one nanoimprint lithography technique, there is photo-imprint lithography in which a photo-curable resin is cured by irradiation with light. In this photo-imprint lithography, the photo-curable resin shrinks in accordance with the intensity of the irradiation light. Thus, the shrinkage of the photo-curable resin may cause variations in the pattern dimensions of the photo-curable resins, thereby causing variations in the sizes of patterns on a transfer substrate as well.

### BRIEF DESCRIPTION OF THE SEVERAL VIEWS OF THE DRAWING

FIG. 1 is a cross-sectional view showing a first template according to a first embodiment.

FIGS. 2A to 2C are cross-sectional views showing a method of fabricating the first template according to the first embodiment.

FIGS. 3A to 3D are cross-sectional views showing a method of forming patterns according to the first embodiment.

### DETAILED DESCRIPTION OF THE INVENTION

An imprint lithography template used according to an embodiment includes a first substrate, and a first photo-curable resin having a first concave-convex pattern is provided on the main surface of the first substrate. A second photo-curable resin having a second concave-convex pattern different in pattern density from the first concave-convex pattern and having optical transmittance different from that of the first photo-curable resin is provided on the main surface of the first substrate.

Hereinbelow, embodiments of the present invention will be described by referring to the drawings.

### First Embodiment

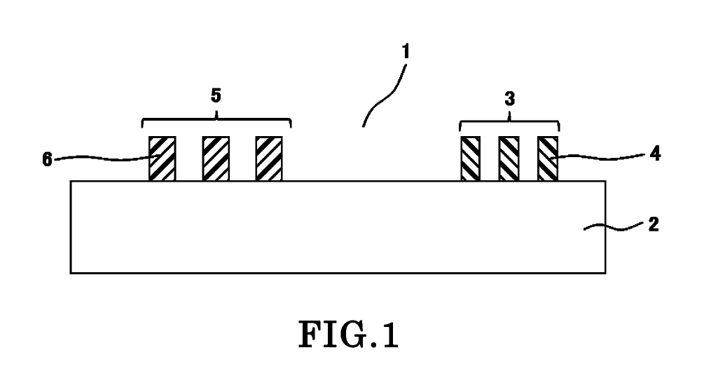

FIG. 1 shows a cross-sectional view of a first template 1 according a first embodiment.

As shown in FIG. 1, the first template 1 is such that a first photo-curable resin 4 having a first concave-convex pattern 3 and a second photo-curable resin 6 having a second concave-convex pattern 5 are provided on the main surface of a first substrate 2. As the first substrate 2, a quartz glass substrate configured to transmit ultraviolet rays is used, for example. The first photo-curable resin 4 and the second photo-curable resin 6 provided on the first template 1 are formed by curing the first photo-curable resin 4 and the second photo-curable resin 6 in a liquid state through photoirradiation. Note that the first photo-curable resin 4 and the second photo-curable resin 6 may be ones cured by electron beam irradiation.

The first photo-curable resin 4 and the second photo-curable resin 6 differ from each other in optical transmittance. For example, materials used are such that the optical transmittance of the first photo-curable resin 4 would be higher than the optical transmittance of the second photo-curable resin 6. The optical transmittance here refers to optical transmittance at the wavelength of the light used in photo-imprint lithography, and refers to optical transmittance at the i-line wavelength, for example. The optical transmittances of the first photo-curable resin 4 and the second photo-curable resin 6 can be altered by means of their respective optical constants. The optical transmittances can be altered by means of their respective refractive indexes or absorption coefficients, for example. Note that the photo-curable resins provided on the main surface of the first substrate 2 are not necessarily limited to the two kinds, the first photo-curable resin 4 and the second photo-curable resin 6; three of more kinds of photo-curable resins may be provided. The description will be given below by assuming that the first photo-curable resin 4 and the second photo-curable resin 6 are provided on the first substrate 2.

The first photo-curable resin 4 has the first concave-convex pattern 3 while the second photo-curable resin 6 has the second concave-convex pattern 5. The first concave-convex pattern 3 and the second concave-convex pattern 5 are line-and-space patterns in each of which the line widths and pitch of for example the raised portions are fixed. The first concave-convex pattern 3 and the second concave-convex pattern 5 are patterns differing from each other in at least one of the line widths and pitch of the raised portions. The first concave-convex pattern 3 has a higher pattern density than that of the second concave-convex pattern 5. That is, at least one of the line widths and pitch of the raised portions in the first concave-convex pattern 3 is smaller than the at least one of the line widths and pitch of the raised portions in the second concave-convex pattern 5.

The intensity of the light passing through the first template 1 is dependent on the pattern density of each of the first concave-convex pattern 3 and the second concave-convex pattern 5, i.e., the line widths and pitch of the raised portions in each pattern. The smaller the line widths and pitch of the raised portions in the pattern, the smaller the intensity of the light passing through the patterned portion. Accordingly, for the light passing through the first template 1 to have an intensity that is substantially uniform over the whole template, the first concave-convex pattern 3 with the higher pattern density uses the first photo-curable resin 4 with optical transmittance higher than that of the second photo-curable resin 6 having the second concave-convex pattern 5 with the lower pattern density. In this way, the intensity of the light passing through the pattern with the lower pattern density can be made substantially equal to the intensity of the light passing through the pattern with the higher pattern density. Accordingly, the photo-curable resins can be irradiated with light with a uniform light intensity inside the region of the first template 1.

The first photo-curable resin 4 and the second photo-curable resin 6 each contain a polysilane, a silicone compound, metal oxide nanoparticles, a solvent, and additives, for example.

As the polysilane, used is one having an excellent solubility and compatibility to an organic solvent and a silicone compound. Using such a polysilane allows formation of a photo-curable resin with a flat surface. As the polysilane, one having a weight average molecular weight from 5000 to 50000 is used, for example, and one having a weight average molecular weight from 10000 to 20000 is preferably used. Moreover, a silane oligomer may be used as the polysilane. The content of the silane oligomer is approximately from 5% by weight to 25% by weight of the whole, for example. Note that for the polysilane, a straight chain polysilane and a branched chain polysilane are available. A branched chain polysilane is preferable for its excellent film formability.

As the silicone compound, used is one compatible to the polysilane and the organic solvent. A silicone compound having a weight average molecular weight from 100 to 10000 is used, for example, and a silicone compound having a weight average molecular weight from 100 to 5000 is preferably used. Also, the silicone compound may contain a double bond-containing silicone compound. The content of the double bond-containing silicone compound is from 20% by weight to 100% by weight, for example, and preferably from 50% by weight to 100% by weight. The weight ratio of the polysilane and the silicone compound is from 80:20 to 10:90, for example, and preferably from 70:30 to 40:60. Containing the silicone compound in such a ratio allows formation of a photo-curable resin excellent in photocurability and low in the amount of cracks.

As the metal of the metal oxide nanoparticles, used is lithium, copper, zinc, strontium, barium, aluminum, yttrium, indium, cerium, silicon, titanium, zirconium, tin, niobium, antimony, tantalum, bismuth, chrome, tungsten, manganese, iron, nickel, ruthenium, an alloy thereof, or the like, for example. As the metal oxide, zirconium oxide, titanium oxide, or zinc oxide is particularly preferable since they have a desired refractive index and an excellent transparency. In addition, the average particle size of the metal oxide nanoparticles is from 1 nm to 100 nm, for example. By adjusting the kind of and the addition amount of the metal oxide nanoparticles, the optical constants of the first photo-curable resin 4 and the second photo-curable resin 6 are controlled, and their optical transmittances can therefore be controlled.

As the solvent, an organic solvent is used. For example, pentane is used as a hydrocarbon solvent with 5 to 12 carbons. Besides pentane, a halogenated hydrocarbon solvent or an ether solvent may be used. As the hydrocarbon solvent, an aliphatic solvent such as hexane, heptane, or cyclohexane, an aromatic solvent such as benzene or toluene, or the like may be used, for example. Moreover, as the halogenated hydrocarbon solvent, carbon tetrachloride, chloroform, dichloromethane, chlorobenzene, or the like may be used. As the ether solvent, diethyl ether, dibutyl ether, tetrahydrofuran, or the like may be used. The amount of the solvent to be used is preferably within such a range that the concentration of the polysilane would be from 10% by weight to 50% by weight.

As the additives, used are a dispersant, a sensitizer which is an organic oxide, and a surface conditioner which is a fluorochemical surfactant.

In the first template 1 according to the first embodiment, on the first substrate 2, the first concave-convex pattern 3 higher in pattern density than the second concave-convex pattern 5 uses the first photo-curable resin 4 higher in optical transmittance than the second photo-curable resin 6. Accordingly, the intensity of the light passing through the first template 1 can be made substantially uniform.

Hereinbelow, a method of fabricating the template according to the first embodiment will be described.

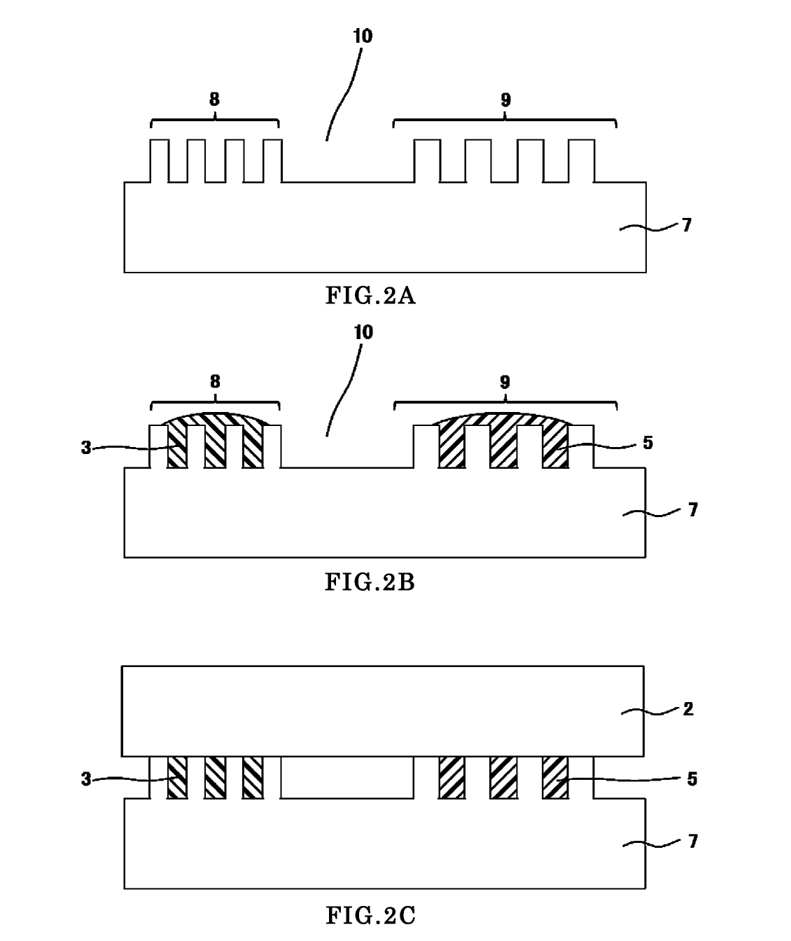

FIGS. 2A to 2C are cross-sectional views showing the method of fabricating the template according to the first embodiment.

On the main surface of a second substrate 7, concave-convex patterns of a third concave-convex pattern 8 and a fourth concave-convex pattern 9 are formed by photolithograph and reactive ion etching (RIE) to thereby form a second template 10 as shown in FIG. 2A. As the second substrate 7, a quartz substrate configured to transmit ultraviolet rays is used, for example.

The third concave-convex pattern 8 and the fourth concave-convex pattern 9 are line-and-space patterns in each of which the line widths and pitch of for example the raised portions are fixed. The third concave-convex pattern 8 and the fourth concave-convex pattern 9 are patterns differing from each other in at least one of the line widths and pitch of the raised portions. The third concave-convex pattern 8 has a higher pattern density than that of the fourth concave-convex pattern 9. That is, at least one of the line widths and pitch of the raised portions in the third concave-convex pattern 8 is smaller than the at least one of the line widths and pitch of the raised portions in the fourth concave-convex pattern 9. The third concave-convex pattern 8 and the fourth concave-convex pattern 9 are desirably subjected to a surface treatment using a release agent containing a silicone compound or the like, for example.

Subsequently, as described later, the intensity of the light to pass through the first template 1 is calculated through simulation with an electromagnetic field analysis, on the basis of the pattern densities of the first concave-convex pattern 3 and the second concave-convex pattern 5 to be formed on the first template 1 correspondingly to the third concave-convex pattern 8 and the fourth concave-convex pattern 9. In this step, the calculation is performed by changing the optical transmittances based on the optical constants in such a way that the calculated intensity of the light to pass through the first template 1 would be substantially uniform over the whole template. The intensity of the light to be applied onto the photo-curable resin varies depending on the density of the pattern formed on the template. This light intensity is smaller when the pattern density is higher, and larger when the pattern density is lower.

Subsequently, as shown in FIG. 2B, the first photo-curable resin 4 and second photo-curable resin 6 in a liquid state are applied onto the third concave-convex pattern 8 and fourth concave-convex pattern 9, respectively. Of the optical transmittances figured out through the simulation, the first photo-curable resin 4 has a relatively high transmittance whereas the second photo-curable resin 6 has a relatively low transmittance, for example. The application is done by selective application using an inkjet method, for example.

Subsequently, as shown in FIG. 2C, the main surface of the first substrate 2 is brought into tight contact with the main surface of the second substrate 7 to pressurize the first photo-curable resin 4 and the second photo-curable resin 6. As a result, the first photo-curable resin 4 and the second photo-curable resin 6 are filled in the recessed portions in the third concave-convex pattern 8 and fourth concave-convex pattern 9 by capillarity.

Subsequently, the first photo-curable resin 4 and second photo-curable resin 6 in the liquid state are cured by irradiation with a given energy beam, e.g., photoirradiation or electron beam irradiation. This curing occurs since the irradiation with the energy beam changes the Si—Si bonds in the polysilane contained in the photo-curable resins into Si—O—Si bonds. In the photoirradiation, ultraviolet rays are used, for example. Note that when the second substrate 7 is a quartz substrate, Si—O—Si bonds are formed between the main surface of the second substrate 7 and the first and second photo-curable resins 4 and 6, thereby further improving the adhesion therebetween. Meanwhile, the first template 2 and the second template 10 may be brought into tight contact with each other after applying the first photo-curable resin 4 and the second photo-curable resin 6 onto the first substrate 2 and positioning the applied first photo-curable resin 4 and second photo-curable resin 6 respectively to the third concave-convex pattern 8 and fourth concave-convex pattern 9 on the second template 10.

Subsequently, the second template 10 is removed from the first substrate 2, whereby the first photo-curable resin 4 having the first concave-convex pattern 3 and the second photo-curable resin 6 having the second concave-convex pattern 5 are formed on the first substrate 2. As a result, the first template 1 is formed such that the light intensity inside the template is adjusted.

The raised and recessed portions in the third concave-convex pattern 8 correspond to the recessed and raised portions in the first concave-convex pattern 3, respectively. The raised and recessed portions in the fourth concave-convex pattern 9 correspond to the recessed and raised portions in the second concave-convex pattern 5, respectively.

Meanwhile, after the formation, the first template 1 may be subjected to a heat treatment at a temperature from 150 to 450° C. for approximately 3 to 20 minutes. In this way, the oxidation reaction of the polysilane contained in each of the first photo-curable resin 4 and the second photo-curable resin 6 can progress further, thereby allowing formation of photo-curable resins excellent in curability. Note that the heating temperature can be changed depending on the purpose. The heat treatment at for example 150 to 200° C. allows the photo-curable resins to have a chemical resistance. Moreover, the heat treatment at for example 400° C. allows the photo-curable resins to have a curability substantially equal to that of a low-melting-point glass.

The above description has been given by assuming the use of photo-imprint lithography in which the first template 1 is fabricated by curing the photo-curable resins through photoirradiation. Note, however, that thermal-imprint lithography in which heat-curable resins are cured through a heat treatment may be used to fabricate the first template 1.

Next, a method of forming patterns according to the first embodiment will be described.

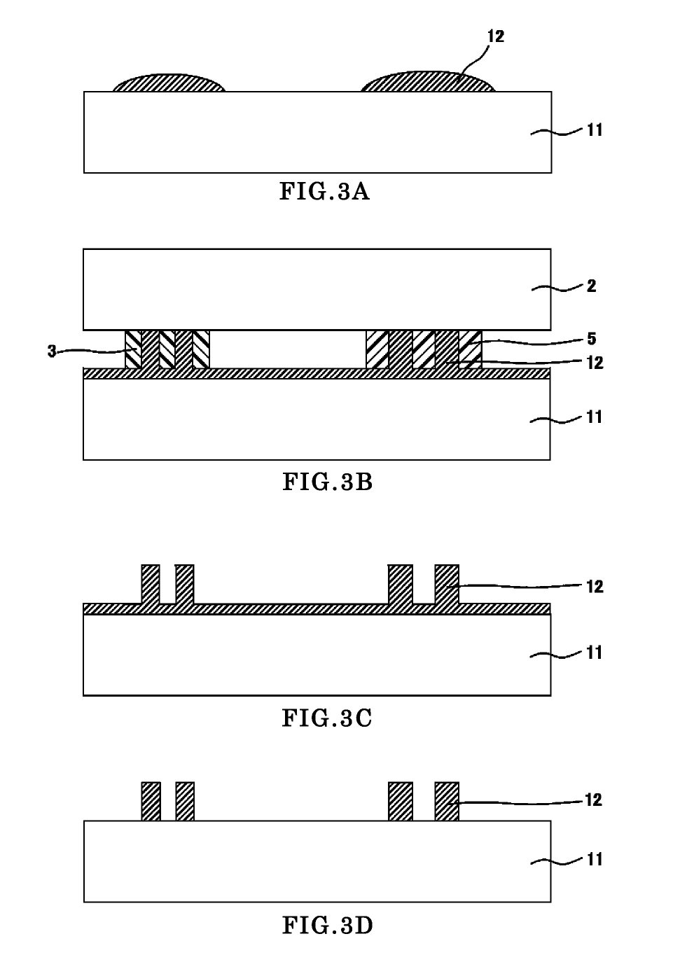

As shown in FIG. 3A, a third photo-curable resin 12 in a liquid state is applied on a transfer substrate 11. The transfer substrate 11 is a silicon substrate, for example. At this point, the third photo-curable resin 12 is in a liquid state. For the third photo-curable resin 12, a photo-curable material is used which is configured to cure upon irradiation with light, e.g., near ultraviolet rays. As the third photo-curable resin 12, one in which an acryl-based resin as a base resin and a photosensitizer are mixed can be used, for example.

Other examples used as the base resin include polyethylene, polypropylene, polyvinyl alcohol, polyvinylidene chloride, polyethylene terephthalate, polyvinyl chloride, polystyrene, ABS resins, AS resins, acryl resins, polyamide, polyacetal, polybutylene terephthalate, glass reinforced polybutylene terephthalate, polycarbonate, modified polyphenylene ether, polyphenylene sulfide, polyether ether ketone, liquid crystalline polymers, fluororesins, polyarylate, polysulfone, polyethersulfone, polyamide-imide, polyether imide, phenol resins, melamine resins, urea resins, epoxy resins, unsaturated polyester resins, alkyd resins, silicone resins, diallyl phthalate resins, polyamide-bismaleimide, polybisamide triazole, or the like, or a mixture of two of more of these resins.

As the photosensitizer, a known initiator is used, examples of which include: phosphine oxides such as 2,4,6-trimethylbenzoyldiphenylphosphine oxide, phenylbis(2,4,6-trimethylbenzoyl)-phosphine oxide, and bis(2,6-dimethoxybenzoyl)-2,4,4-trimethyl-pentylphosphine oxide; thioxanthones such as 2,4-diethylthioxanthone, 2-chlorothioxanthone, and 1-chloro-4-propoxythioxanthone; ketones such as N-methylacridone, bis(dimethylaminophenyl) ketone, and 2-benzyl-2-dimethylamino-1-(4-morpholinophenyl)-butan-1-one; oximes such as 1,2-octanedione-1-(4-(phenylthio)-2,2-(o-benzoyloxime)); acetophenones such as 2,2-dimethoxy-1,2-diphenylethane-1-one, 1-hydroxy-cyclohexyl-phenyl-ketone, and 2-hydroxy-2-methyl-1-phenyl-propane-1-one; benzoins; benzophenones; ketals; anthraquinones; and the like.

Subsequently, as shown in FIG. 3B, the first template 1 is pressed against the third photo-curable resin 12 in the liquid state on the transfer substrate 11 to bring the first template 1 and the third photo-curable resin 12 into tight contact with each other, so that the third photo-curable resin 12 is pressurized. As a result, part of the third photo-curable resin 12 is filled in the recessed portions in the first concave-convex pattern 3 and second concave-convex pattern 5 on the first template 1.

Subsequently, in the state where the third photo-curable resin 12 is in tight contact with the first template 1, the third photo-curable resin 12 is irradiated with light, e.g. i-lines as near ultraviolet rays, through the first template 1. Accordingly, the third photo-curable resin 12 in the liquid state irradiated with the light is cured. For the wavelength of the light to be used to photo-cure the third photo-curable resin 12, the first template 1 has been adjusted such that the intensity of the light to pass through the first template 1 would be substantially uniform over the whole first template 1. Hence, when photo-cured, the third photo-curable resin 12 shrinks uniformly on the whole transfer substrate 11.

Subsequently, as shown in FIG. 3C, the first template 1 is removed from the third photo-curable resins 12, whereby the third photo-curable resin 12 in which the first concave-convex pattern 3 and the second concave-convex pattern 5 are transferred is formed on the transfer substrate 11.

Subsequently, as shown in FIG. 3D, the base layer of the third photo-curable resin 12 is removed by drying etching such as RIE to expose the transfer substrate 11. Then, the transfer substrate 11 is etched by RIE or the like using the third photo-curable resin 12 as a mask to form a desired pattern in the transfer substrate 11.

As described above, in the first embodiment of the present invention, for the wavelength of the light to be used to photo-cure the third photo-curable resin 12, the first template 1 is adjusted such that the intensity of the light to pass therethrough would be substantially uniform over the whole first template 1. In other words, when photo-cured, the third photo-curable resin 12 shrinks uniformly on the whole transfer substrate 11. Accordingly, the patterns on the first template 1 can be well transferred as patterns in the photo-curable resin on the transfer substrate 11.

Note that the above description has been given by using the first photo-curable resin 4 and the second photo-curable resin 6 on the first template 1; however, the photo-curable resins are not limited to these two kinds, and three or more kinds of photo-curable resins differing in optical transmittance may be used.

What is claimed is:

1. An imprint lithography template used in photo-imprint lithography comprising:
a first substrate;
a first photo-curable resin provided on a main surface of the first substrate and having a first concave-convex pattern; and
a second photo-curable resin provided on the main surface of the first substrate, having a second concave-convex pattern different in pattern density from the first concave-convex pattern, and having optical transmittance different from that of the first photo-curable resin.

2. The imprint lithography template according to claim 1, wherein
the pattern density of the first concave-convex pattern is higher than the pattern density of the second concave-convex pattern, and
the optical transmittance of the first photo-curable resin is higher than the optical transmittance of the second photo-curable resin.

3. The imprint lithography template according to claim 1, wherein the first concave-convex pattern and the second concave-convex pattern are line-and-space patterns.

4. The imprint lithography template according to claim 1, wherein the first photo-curable resin and the second photo-curable resin differ from each other in refractive index and absorption coefficient.

5. The imprint lithography template according to claim 1, wherein the first photo-curable resin and the second photo-curable resin each contain a polysilane, a silicone compound, and metal oxide nanoparticles.

6. The imprint lithography template according to claim 5, wherein the metal oxide is selected from one of zirconium oxide, titanium oxide, and zinc oxide.

7. The imprint lithography template according to claim 5, wherein a weight average molecular weight of the polysilane is from 5000 to 50000.

8. The imprint lithography template according to claim 5, wherein a weight average molecular weight of the silicone compound is from 100 to 10000.

9. The imprint lithography template according to claim 5, wherein an average particle size of the metal oxide nanoparticles is from 1 to 100 nm.

10. A method of fabricating an imprint lithography template comprising:
forming a first concave-convex pattern and a second concave-convex pattern on a main surface of a first substrate, the second concave-convex pattern being different in pattern density from the first concave-convex pattern;
applying a first photo-curable resin and a second photo-curable resin on the first concave-convex pattern and the second concave-convex pattern, respectively, the second photo-curable resin having optical transmittance different from that of the first photo-curable resin;
bringing a main surface of a second substrate into tight contact with the main surface of the first substrate; and
curing the first photo-curable resin and the second photo-curable resin through irradiation with an energy beam.

11. The method of fabricating an imprint lithography template according to claim 10, wherein
the pattern density of the first concave-convex pattern is higher than the pattern density of the second concave-convex pattern, and
the optical transmittance of the first photo-curable resin is higher than the optical transmittance of the second photo-curable resin.

12. The method of fabricating an imprint lithography template according to claim 10, wherein the first photo-curable resin and the second photo-curable resin differ from each other in refractive index and absorption coefficient.

13. The method of fabricating an imprint lithography template according to claim 10, wherein the energy beam is selected from one of a light beam and an electron beam.

14. The method of fabricating an imprint lithography template according to claim 10, further comprising performing a heat treatment after the irradiation with the energy beam.

15. The method of fabricating an imprint lithography template according to claim 10, wherein the application of the first photo-curable resin and the second photo-curable resin is performed by using an inkjet method.

16. The method of fabricating an imprint lithography template according to claim 10, wherein the first photo-curable resin and the second photo-curable resin each contain a polysilane, a silicone compound, and metal oxide nanoparticles.

17. A method of forming a pattern comprising:
applying a third photo-curable resin on a transfer substrate;
bringing a main surface of the template according to claim 1 into tight contact with the third photo-curable resin;
curing the third photo-curable resin by irradiating the third photo-curable resin with light; and
etching the transfer substrate by using the third photo-curable resin as a mask.
